(19) United States
(12) Patent Application Publication
(10) Pub. No.: US 2006/0249499 A1
(43) Pub. Date: Nov. 9, 2006

(54) Heating unit

(76) Inventor: Wolfgang Arno Winkler, St. Georgen (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/416,649

(22) Filed: May 2, 2006

(30) Foreign Application Priority Data
May 6, 2005 (DE) 20 2005 007 499.3

(51) Int. Cl. B60L 1/02

(52) U.S. Cl. 219/202

(57) ABSTRACT

An electric heating unit, adapted for installation in motor vehicles such as cars, boats or small airplanes, has a fan module releasably coupled to an electric heating register module. A suitable coupling means is a bayonet socket. The fan module has a tubular housing with a mounting flange at the air inflow end, an internal stator, and an external rotor formed with projecting fan blades. The heating module preferably couples on at the air outflow end of the fan housing, and includes an annular carrier, supporting either a star-shaped electrical resistance element or a serpentine looped electrical resistance wire. The outlet end of the heating module can be formed with another coupling means, for example to attach elbow tubes or the like. Preferably, the unit's weight does not exceed 125 grams and its largest dimension does not exceed 75 mm.

### CROSS-REFERENCE

This application claims priority under section 119 of German application DE 20 2005 007 499.3 of 6 May 2005, the contents of which are hereby incorporated by reference.

### FIELD OF THE INVENTION

The present invention relates to a heating unit, and, more particularly, to a heating unit adapted for installation in a vehicle.

### BACKGROUND

Vehicles of more recent design have drive systems with efficiencies that are very greatly improved, as compared with earlier engines. This means that little waste heat is available for heating such vehicles; in other words, if additional steps are not taken, their occupants freeze when the weather is cold. This applies in particular to diesel vehicles, but also to vehicles having fuel-cell drive systems and to gasoline-powered vehicles having a hybrid drive system.

Auxiliary heating units, which are operated sometimes with fuel and sometimes with electricity, are used for this reason.

Such heating units should be effective immediately upon starting, in order to heat up the passenger compartment, driver's seat, steering wheel, windshield, diesel fuel filter, etc., and to thereby enhance traffic safety.

It is possible, for this purpose, in the first few minutes after starting, to blow heated air by means of a small electrical heating unit into the driver's seat, likewise into the rear footwell and onto the diesel fuel filter, in order to prevent precipitation of paraffin therein.

### SUMMARY OF THE INVENTION

It is therefore an object of the invention to provide a new heating unit.

According to the invention, this object is achieved by a heating unit in which a fan driven by an external rotor motor is arranged inside a tubular housing, and a heating register module latches to one end of the tubular fan housing. A heating unit of this kind can be very compact in size. The latching connection results in a modular construction, so that, depending on customer requirements, heating registers of different performance levels can be coupled—even, for example, via angle pieces or the like—to the fan housing. Higher-performance registers will be used for applications in Arctic regions than in the case of a tropical country. This construction also facilitates cleaning of such a unit, and the swapping-out or replacement of defective parts if applicable.

A preferred refinement of the invention is to form the heating register as a carrier supporting an electrical resistance element which is formed with a through passage for flow of the air to be heated, which yields a very compact heating unit with good performance.

According to a preferred embodiment, the heating unit advantageously incorporates an already-known miniature fan. Miniature fans (or mini-fans) of this kind have very small dimensions. They are used especially in electronic products as active cooling elements, and combine a very compact design with low expense, sufficient service life, and high efficiency. For example:

ebm-papst 400F-series fans have dimensions of 10×40×40 mm; those of the ebm-papst 400 series, dimensions of 20×40×40 mm; and

ebm-papst 600-series fans have dimensions of 25×60×60 mm. The power consumption of such fans is 0.7-0.9 W for the 400F series, and 0.9-3.4 W for the 400 and 600 series. The weight is, for example, between 17 and 27 g for the 400/400F series, and approximately 85 g for the 600 series.

Further details and advantageous refinements of the invention are evident from the embodiments, in no way to be understood as limitations of the invention, that are described below and shown in the drawings.

### BRIEF FIGURE DESCRIPTION

FIG. 1 is three-dimensional view of a preferred configuration of a heating unit according to the present invention, having a first embodiment of a heating register according to the invention, in the state prior to coupling of the fan and heating register modules;

FIG. 2 is an enlarged view showing a portion of FIG. 1, in order to illustrate the coupling means in greater detail; and

FIG. 3 shows a second embodiment of a heating register according to the invention.

### DETAILED DESCRIPTION

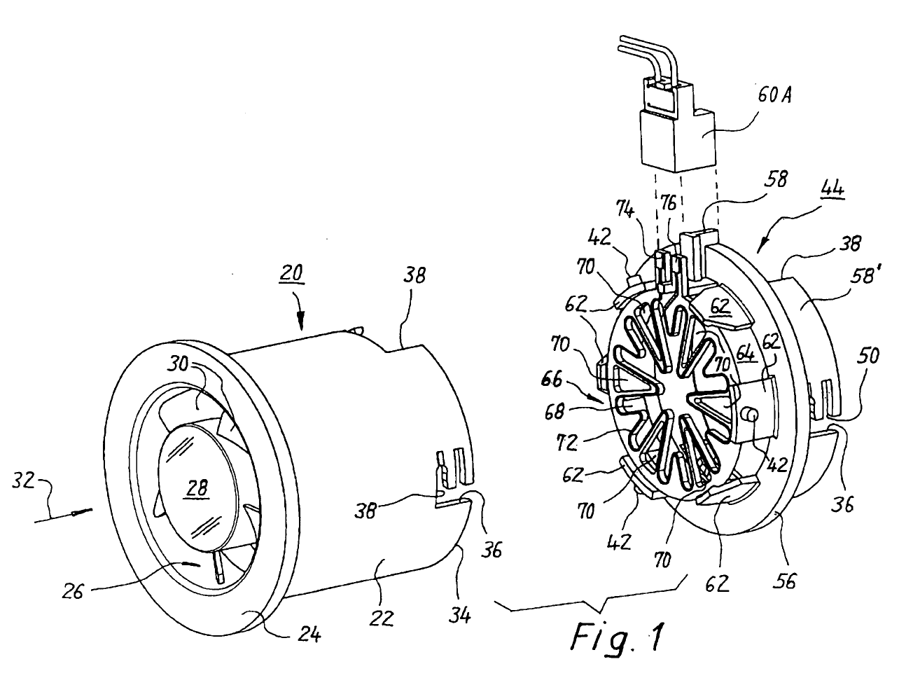

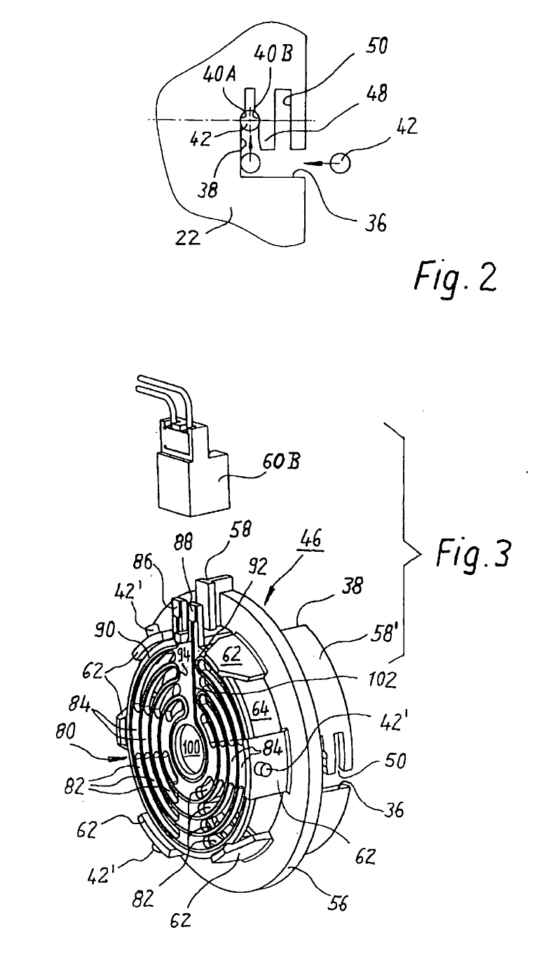

FIG. 1 shows, on the left, a so-called “tube fan” 20. This has a tube 22 that is provided on the left, in the manner shown, with a mounting flange 24. Mounted in this tube 22 by means of spokes or struts (not shown) is the internal stator (not shown) of the fan. Around the stator is an external rotor 28, adapted for rotation about a longitudinal axis of the stator. On the periphery of rotor 28 are mounted fan blades 30 that, during operation, transport air axially through tube 22 in the direction of an arrow 32. Rotor 28, during operation, rotates around the axis of the internal stator. For this reason, a fan of this kind is called an “axial fan.” FIG. 1 shows the inflow side of fan 26 on the left, and the outflow side on the right. Preferably, the largest dimension of this module does not exceed 75 mm, which facilitates installation for vehicular uses. If one uses one of the aforementioned series 400 or 400F or 600 fans, the dimensions will be even smaller.

Tube 22 has, at its right end 34, three cutouts, of which only cutouts 36 and 38 are visible. Two recesses extending in the circumferential direction are located on the upper (in the drawing) periphery of cutout 36. A left recess 38 has an enlargement 40A, 40B that serves for latching with a peg 42 that is provided on a heating register 44, or for latching with a peg 42′ on a heating register 46 that is shown in FIG. 3.

Located to the right of the left recess 38 is a resilient latching tongue 48, and to the right of that, a right recess 50 that extends parallel to recess 38 and enables latching tongue 48, upon introduction of a latching peg 42 or 42′, to deflect resiliently to the right, and likewise, upon removal of such a latching peg, to deflect in the opposite direction. Such structures are sometimes referred to as a bayonet socket.

Corresponding latching recesses are located in cutout 38 and in the third cutout (not visible in FIG. 1) of tube 22.

### THE HEATING REGISTER MODULE

FIGS. 1 and 3 show, as examples, the two heating registers 44 and 46. These have the same basic structure, but differ in terms of the elements for electrical heating. Corresponding elements are therefore labeled with the same reference characters and are usually described only once.

Both heating registers have an annular carrier 56, on which is provided, at the top, an electrical connector element 58 that serves for connection to a connector plug 60A or 60B. Cutout 38 serves to receive connector element 58, and is therefore particularly wide.

Extending to the right from carrier 56 is a tubular extension 58′ whose configuration corresponds to the structure at right end 34 of tube 22, the same reference characters therefore being used for identical or identically functioning parts.

Protruding to the left, in the axial direction from annular carrier 56, are a total of six guide segments 62 that are each at a spacing of 60° from one another. Three of guide segments 62 are equipped with latching pegs 42 or 42′. These each have spacings of 120°. Guide segments 62 are dimensioned so that they fit into tube 22 and are guided by it.

The actual electrical heating element is mounted an guide segments 62 and is therefore located in an open passage 64 chat is defined by annular carrier 56, so that the air conveyed by fan 26 flows through this heating element and is thereby heated.

In the case of heating register 44 according to FIG. 3, the heating element takes the form of a very highly thermally conductive plate 66 having a central star-shaped aperture 68 and a total of six additional apertures 70 provided in its peripheral region. This plate can be produced from metal or from a heat-resistant, highly thermally conductive plastic. The same applies analogously to plate 80 shown in FIG. 3. Plates 66 and 80 are electrically heated, and deliver their heat to the air flowing through. The temperature of the air flowing through can be influenced very easily by controlling the rotation speed of fan 26, e.g. by means of a temperature controller. For that purpose, the temperature of the air flowing out of heating register 44 or 46 is sensed, in known fashion, by means of a sensor (not shown). Alternatively, regulation of the power delivered to the relevant heating register is also possible.

Extending along the peripheries of central aperture 68 is a peripheral lining 72 made of heat-resistant conductive material, for example metal, which serves both to protect the edges of aperture 68 and as a heating wire. The latter runs between two electrical terminals 74 and 76 that serve for connection to plug 60A. The layout of the electrical connections and of the heating wire is clearly apparent from FIG. 1. In order to simplify manufacture, terminals 74 and 76 are preferably portions of plate 66.

FIG. 3 shows heating register 46. This has a heating element in the form of a plate 80 having a total of sixteen apertures 82 in the form of annulus sectors, which each extend over approximately 50° and are separated from one another by four solid segments 84, each having an angular extent of approximately 40°.

Plate 80 also has, in this case, lateral extensions 86, 88 forming electrical terminals that serve for connection to plug 68B. Proceeding from terminal 86 is a connection to a heating conductor 90, running in the circumferential direction, that extends approximately 330° counterclockwise, then reverses direction at 92 and runs back in the opposite direction to a reversing point 94, and so forth. The innermost portion of heating conductor 90 surrounds a central opening 100 and is connected to electrical terminal 88 via a radial portion 102. As is evident, each of the apertures 82 is contacted, on at least one peripheral segment, by heating conductor 90. Heating conductor 90 is usefully applied as a film onto plate 80, in order to simplify manufacture.

As is apparent from the drawings, either heating register 44 or heating register 46 can be coupled to tubular housing 22. Preferably, the weight of the heating module does not exceed 40 grams, so the fan module and heating module together do not exceed 125 grams.

It is also possible, as shown by FIG. 1, to connect heating register 44 to tube 22, and then to connect heating register 46 to heating register 44. The fact that the design is modular results in a wide range of variability. It is also possible, for example, first to connect a connecting elbow (not shown) to tube 22, in order to deflect the cold air emerging from tube 22, for example 90° downward, and then to connect one or more heating registers to the free end of that elbow, in order to achieve a high heat concentration precisely at a desired location, for example at the diesel fuel filter of an engine.

Many variants and modifications are, of course, possible within the scope of the present invention.

What is claimed is:

1. An electric heating unit adapted for vehicular use, comprising:
a fan housing (22);
a motor with an external rotor (28), in said housing;
a plurality of fan blades (30) arranged on said rotor for transport of air through said fan housing (22); and
at least one electrical heating register module (44, 46) releasably coupling to said fan housing (22) via a releasable engagement means.

2. The electric heating unit of claim 1, wherein said releasable engagement means is a bayonet socket (38,42).

3. The electric heating unit of claim 1, further comprising a carrier (66, 80) for an electrical resistance heating element (72, 90), said carrier being formed with a passage (68,82) for flow of air to be warmed by said resistance heating element.

4. The electric heating unit of claim 3, wherein said heating element (46) defines an air transport passage (68) at whose periphery a lining (72) of conductive heat-resistant material is provided, formed with terminals (74, 76) for applying electrical energy to the heating element (46).

5. The electric heating unit of claim 3, wherein said resistance heating element is configured, in at least one region thereof, as a heating wire.

6. The electric heating unit of claim 5, wherein
said heating element (46) defines an air transport passage (68) at whose periphery a lining (72) of conductive heat-resistant material is provided, formed with terminals (74, 76) for applying electrical energy to the heating element (46).

7. The electric heating unit of claim 1, wherein said electrical heating register module (44, 46) is formed with at least one terminal (74, 76; 86, 88) for application of electrical energy.

8. The electrical heating unit of claim 1, wherein said
at least one heating register module (44,46) is arranged at an air outflow side of said fan housing (22).

9. The electric heating unit of claim 1, wherein said
fan housing (22), with said external rotor (28) and fan blades (30) contained therein, has a largest dimension not exceeding 75 mm.

10. The electric heating unit of claim 1, wherein a combined weight of said fan housing (22), motor, and heating register module does not exceed 125 grams.
